(19) United States
(12) Patent Application Publication
(10) Pub. No.: US 2005/0219779 A1
(43) Pub. Date: Oct. 6, 2005

(54) Surge protection circuit

(76) Inventor: Moo-Chang Kim, Seoul (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/096,314

(22) Filed: Mar. 31, 2005

(30) Foreign Application Priority Data
Apr. 1, 2004 (KR) 10-2004-22584

(51) Int. Cl. H02H 9/00

(52) U.S. Cl. 361/56

(57) ABSTRACT

A surge protection circuit for protecting a terminal from direct current (DC) surge is disclosed. The surge protection circuit includes: an surge detecting unit for comparing a line voltage to a threshold voltage and activating a turn-off signal for surge protection; and a switching unit for passing the line voltage and cutting-off the line voltage when the turn-off signal turns the “activated” signal.

### FIELD OF THE INVENTION

The present invention relates to a surge protection circuit; and, more particularly, to a surge protection circuit for protecting a terminal from direct current (DC) surge.

### DESCRIPTION OF RELATED ARTS

A terminal includes a mobile communication terminal, a personal communication station (PCS), a personal digital assistance (PDA), a smart phone, a next generation mobile communication terminal capable of handling data based on an International Mobile Telecommunication 2000 (IMT-2000) and a wireless local area network terminal.

FIG. 1 is a diagram showing a conventional surge protection circuit. Referring to FIG. 1, the conventional surge protection circuit is explained hereinafter.

As shown in FIG. 1, the conventional surge protection circuit includes a DC input unit 110 and a poly-switch 120.

The DC input unit 110 receives a direct current (DC) from an external power source through a DC plug and transfers the received DC to the poly-switch 120. The poly-switch 120 has a first end connected to the DC input unit 110 and a second end connected to a battery or a terminal including the conventional circuit. The poly-switch 120 protects the terminal from surge by being automatically turned off when the surge is applied from the external power source.

According to the conventional surge protection circuit, the surge is protected by the poly-switch's bimetal characteristics. That is, the poly-switch 120 comes to be automatically switched off based on the bimetal characteristics of the poly-switch for cutting off the current when the current having intensity stronger than a predetermined intensity is applied. After opened, the poly-switch 12 automatically comes to a short state after a predetermined time passed according to the bimetal characteristics.

However, the convention surge protection circuit cannot instantly cope with surge because of bimetal characteristics. The conventional surge protection circuit comes to be switched off after damaging the terminal having the conventional surge protection circuit. Accordingly, the conventional surge protection circuit may not protect the terminal when comparatively high intensity surge is applied. That is, the terminal may be burned or a line is shorted by slow response characteristics of the poly-switch 120.

### SUMMARY OF THE INVENTION

It is, therefore, an object of the present invention to provide a surge protection circuit by using a switch having a diode and a transistor for instantly coping with surge in order to sufficiently protect a terminal having the surge protection circuit.

In accordance with an aspect of the present invention, there is also provided a surge protection circuit of a terminal, which includes: a surge detecting unit for comparing a line voltage to a threshold voltage and activating a turn-off signal for surge protection; and a switching unit for switching off the line voltage when the turn-off signal turns the “activated” signal.

### BRIEF DESCRIPTION OF THE DRAWINGS

The above and other objects and features of the present invention will be better understood with regard to the following description of the preferred embodiments given in conjunction with the accompanying drawings, in which:

FIG. 1 is a diagram showing a conventional surge protection circuit;

FIG. 2 is a diagram illustrating a surge protection circuit in accordance with a preferred embodiment of the present invention; and

FIG. 3 is a detailed diagram illustrating the surge protection circuit of a terminal in FIG. 2 in accordance with a preferred embodiment of the present invention.

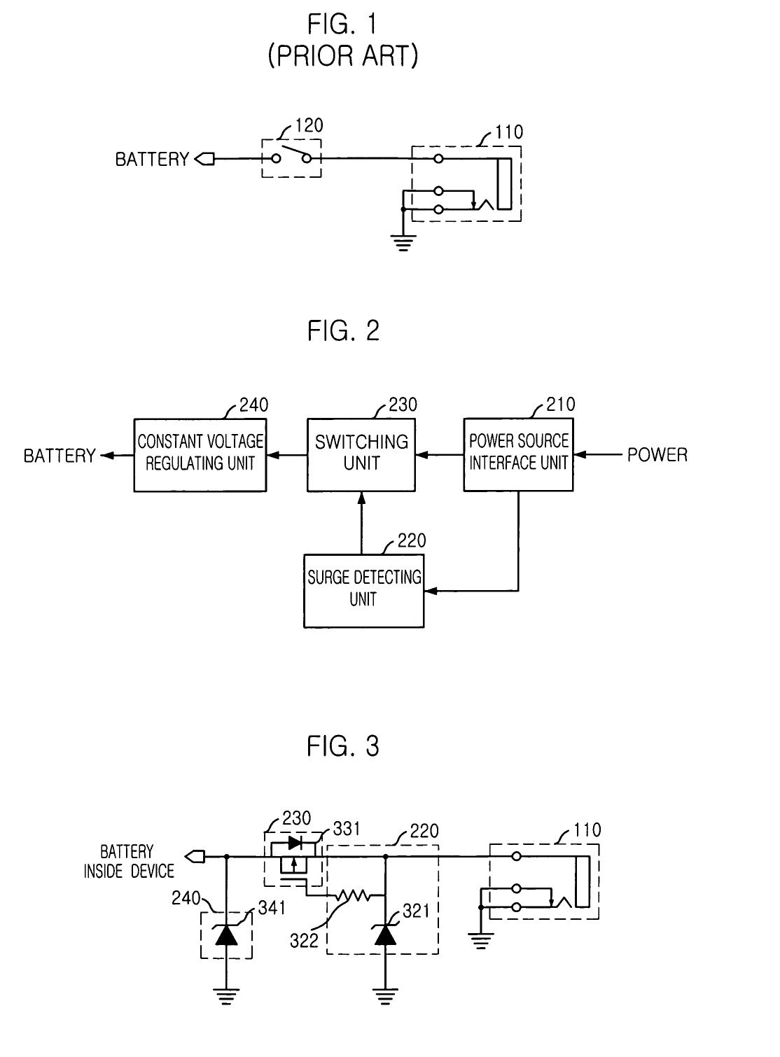

### DETAILED DESCRIPTION OF THE INVENTION

Hereinafter, a surge protection circuit in accordance with a preferred embodiment of the present invention will be described in more detail with reference to the accompanying drawings.

FIG. 2 is a diagram illustrating a surge protection circuit in accordance with a preferred embodiment of the present invention.

As shown in FIG. 2, the surge protection circuit includes a power source interfacing unit 210, a surge detecting unit 220, a switching unit 230 and a constant voltage regulating unit 240.

The power source interfacing unit 210 receives a line voltage from an external power source and transfers the received line voltage to the surge detecting unit 220 and the switching unit 230.

Herein, the power source interfacing unit 210 is generally a DC input unit. Accordingly, the line voltage may be a direct current (DC) but it is not limited to the DC.

The surge detecting unit 220 receives the line voltage from the power source interfacing unit 210 and compares the received line voltage with a predetermined threshold voltage. If the received line voltage goes beyond the predetermined threshold voltage, the surge detecting unit 220 activates a turn-off signal for surge protection and outputs the activated turn-off signal to the switching unit 230.

Herein, the threshold voltage is predetermined according to characteristics of equipped elements i.e., Zenor diode, but the threshold voltage may be in the range of 4.5V to 5.0V.

The surge detecting unit 220 may be a surge protection circuit having the line voltage as an input voltage or an operation voltage and having the turn-off signal as an output voltage. But the surge detecting unit 220 is not limited to the OVP circuit.

The switching unit 230 switches off in order to cut off supply of the current into the constant voltage regulating unit 240 when the turn-off signal is applied from the surge detecting unit 220.

The constant voltage regulating unit 240 regulates the line voltage passed through the switching unit 230 into a predetermined voltage below the threshold voltage.

FIG. 3 is a detailed diagram illustrating the surge protection circuit of a terminal in FIG. 2 in accordance with a preferred embodiment of the present invention.

As shown in FIG. 3, the surge detecting unit 220 includes a first Zenor diode 321 and a resister 322.

The first Zenor diode 321 has a cathode connected to a ground and an anode connected to an input end of the line voltage. If the surge is applied to the anode, the first Zenor diode 321 is turned on to activate the turn-off signal.

The resister 322 has a first end connected to the anode of the first Zenor diode 321 and a second end as an output end of the turn-off signal.

The switching unit 230 includes a PFET 441. The PFET 331 has a gate end connected to the output end of turn-off signal; and a source end for receiving the line voltage from the power source interfacing unit 210 and providing the line voltage passed through a drain end.

The constant voltage regulating unit 240 includes a second Zenor diode 341 having a cathode connected to a ground and an anode connected to the output end of the switching unit 230 for regulating the line voltage into a certain predetermined voltage below below the threshold voltage.

Hereinafter, the surge protection circuit is explained with reference to FIGS. 2 and 3.

If the surge is applied to the surge protection circuit, the first Zenor diode 321 in the surge detecting unit 220 is turned on for activating the turn-off signal to a first logical level (Low). That is, a voltage of the first logical level (Low) is applied to the second end of the resister 322 in the surge detecting unit 220.

After then, the turn-off signal is applied to the switching unit 220 and the PFET 331 in the switching unit 230 is turn off. Finally, the supply of the current into the constant voltage regulating unit 240 is cut off by the PFET 331.

On the contrary, if the surge is not applied to the surge protection circuit, the first Zenor diode 321 in the surge detecting unit 220 is turned off and thus the turn-off signal turns the “deactivated” signal since the turn-off signal turns into a second logical level (High).

After then, the turn-off signal of the second logical level (High) is applied to the switching unit 220 and the PFET 331 is turned on. Finally, the line voltage is applied to the turned-on PFET 331. That is, a voltage of the second logical level (High) is applied to the second end of the resistor 322 in the surge detecting unit 220.

As mentioned above, the present invention can instantly cope with the surge by using economical elements such as a diode and a transistor instead of using the poly-switch for protecting the terminal from the surge. Therefore, the present invention can sufficiently protect the terminal from the surge and also have economical advantage.

The present application contains subject matter related to Korean patent application No. 2004-0022584, filed in the Korean patent office on Apr. 1, 2004, the entire contents of which being incorporated herein by reference.

While the present invention has been described with respect to certain preferred embodiments, it will be apparent to those skilled in the art that various changes and modifications may be made without departing from the spirits and scope of the invention as defined in the following claims.

1. A surge protection circuit of a terminal, comprising:
a surge detecting unit for comparing a line voltage to a threshold voltage and generating a signal for surge protection;
a switching unit for cutting off supply of the current into main circuitry when the signal turns to be a predetermined logical level.

2. The surge protection circuit, further comprising:
a constant voltage regulating unit for regulating the line voltage from the switching unit into a predetermined voltage.

3. The surge protection circuit as recited in claim 1, wherein the surge detecting unit includes:
a first Zenor diode having a cathode connected to a ground and an anode connected to an input end of the line voltage; and
a resistor having a first end connected to the anode of the first Zenor diode and a second end for outputting the turn-off signal as an output end.

4. The surge protection circuit as recited in claim 1, wherein the switching unit includes a PFET having a gate end connected to the output end of the turn-off signal, a source end connected to the input end of the line voltage and a drain end for receiving the passed line voltage.

5. The surge protection circuit as recited in claim 2, wherein the constant voltage regulating unit includes a second Zenor diode having a cathode connected to a ground and an anode connected to the output end of the switching unit.
